(19) United States
(12) Patent Application Publication
(10) Pub. No.: US 2025/0259275 A1
(43) Pub. Date: Aug. 14, 2025

(54) IMAGE MODEL PROCESSING AND IMAGE PROCESSING

(71) Applicant: Tencent Technology (Shenzhen) Company Limited, Shenzhen (CN)

(72) Inventor: Zhihuai XIE, Shenzhen (CN)

(73) Assignee: Tencent Technology (Shenzhen) Company Limited, Shenzhen (CN)

(21) Appl. No.: 19/098,945

(22) Filed: Apr. 2, 2025

Related U.S. Application Data
(63) Continuation of application No. PCT/CN2023/140183, filed on Dec. 20, 2023.

(30) Foreign Application Priority Data
Jan. 13, 2023 (CN) 202310076913.0

(51) Int. Cl. G06T 5/60; G06T 3/4053; G06T 5/20; G06T 5/70

(52) U.S. Cl. CPC G06T 5/60; G06T 3/4053; G06T 5/20; G06T 5/70; G06T 2207/20081

(57) ABSTRACT

In a method of image model processing, an image model is acquired, the image model includes a first feature reconstruction module configured to extract feature information of training data, the first feature reconstruction module includes at least two branches. Reconstruction processing based on merging is performed on the at least two branches of the first feature reconstruction module to obtain a second feature reconstruction module, the second feature reconstruction module has a reduced number of branches compared to the first feature reconstruction module, and the second feature reconstruction module is configured to extract feature information of a to-be-processed image. The first feature reconstruction module in the image model is replaced with the second feature reconstruction module to obtain an optimized image model, the optimized image model is configured to perform image quality enhancement processing on the to-be-processed image. Apparatus and non-transitory computer-readable storage medium counterpart embodiments are also contemplated.

### RELATED APPLICATIONS

The present application is a continuation of International Application No. PCT/CN2023/140183, filed on Dec. 20, 2023, which claims priority to Chinese Patent Application No. 202310076913.0, filed on Jan. 13, 2023. The entire disclosures of the prior applications are hereby incorporated by reference.

### FIELD OF THE TECHNOLOGY

This application relates to the field of computer technologies, including image model processing, and image processing.

### BACKGROUND OF THE DISCLOSURE

With the advancement of technological research and the continuous increase of network data transmission speed, people's requirements for the quality of images and videos (such as image resolution and image fidelity) have also increased. The presentation of high-quality images not only depends on the network data transmission speed, but also depends on the efficiency of an image model in performing image quality enhancement processing on images (for example, performing super-resolution processing and noise reduction on images). Practice has found that to ensure the effect of image quality enhancement, the efficiency of the image model in performing image quality enhancement processing on images is usually low.

### SUMMARY

Embodiments of this disclosure provide an image model processing method, an image processing method, and related apparatuses, which can improve the efficiency of an image model in performing image quality enhancement processing.

Some aspects of the disclosure provide a method of image model processing. In some examples, an image model is acquired, the image model includes a first feature reconstruction module configured to extract feature information of training data, the first feature reconstruction module includes at least two branches. Reconstruction processing is performed on the at least two branches of the first feature reconstruction module to obtain a second feature reconstruction module, the second feature reconstruction module has a reduced number of branches compared to the first feature reconstruction module, the at least two branches of the first feature reconstruction module are merged into the reduced number of branches of the second feature reconstruction module, and the second feature reconstruction module is configured to extract feature information of a to-be-processed image. The first feature reconstruction module in the image model is replaced with the second feature reconstruction module to obtain an optimized image model, the optimized image model is configured to perform image quality enhancement processing on the to-be-processed image.

Some aspects of the disclosure provide an apparatus for image model processing. The apparatus includes processing circuitry (for example, one or more processors) configured to acquire an image model, the image model includes a first feature reconstruction module configured to extract feature information of training data, the first feature reconstruction module includes at least two branches. The processing circuitry is also configured to perform reconstruction processing on the at least two branches of the first feature reconstruction module to obtain a second feature reconstruction module, the second feature reconstruction module has a reduced number of branches compared to the first feature reconstruction module, and the second feature reconstruction module is configured to extract feature information of a to-be-processed image. The processing circuitry can replace the first feature reconstruction module in the image model with the second feature reconstruction module to obtain an optimized image model, the optimized image model being configured to perform image quality enhancement processing on the to-be-processed image.

According to an aspect, an embodiment of this disclosure provides an image model processing method. In the method, an image model is acquired, the image model including a first feature reconstruction module configured to extract feature information of training data, the first feature reconstruction module including at least two branches. Reconstruction processing is performed on the at least two branches of the first feature reconstruction module to obtain a second feature reconstruction module, the number of branches included in the second feature reconstruction module being less than the number of branches included in the first feature reconstruction module, and the second feature reconstruction module being configured to extract feature information of a to-be-processed image. The first feature reconstruction module in the image model is replaced with the second feature reconstruction module to obtain an optimized image model, the optimized image model being configured to perform image quality enhancement processing on the to-be-processed image.

In the embodiment of this disclosure, the image model is acquired. The image model includes the first feature reconstruction module, the first feature reconstruction module includes at least two branches, and reconstruction processing is performed on the at least two branches of the first feature reconstruction module to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model, and the optimized image model is configured to perform image quality enhancement processing on the to-be-processed image. By replacing the first feature reconstruction module of the image model with the second feature reconstruction module, the number of branches of the feature reconstruction module can be reduced, thus reducing the number of parameters of the image model to improve the efficiency of the image model in performing image quality enhancement processing.

According to another aspect, an embodiment of this disclosure provides an image processing method. In the method, an image model is acquired, the image model including a first feature reconstruction module configured to extract feature information of training data, the first feature reconstruction module including at least two branches. Reconstruction processing is performed on the at least two branches of the first feature reconstruction module to obtain a second feature reconstruction module, the number of branches included in the second feature reconstruction module being less than the number of branches included in the first feature reconstruction module, and the second feature reconstruction module being configured to extract feature information of a to-be-processed image. The first feature reconstruction module in the image model is replaced with the second feature reconstruction module to obtain an optimized image model. The to-be-processed image is inputted into the optimized image model and image quality enhancement processing is performed.

In the embodiment of this disclosure, the image model is acquired. The image model includes the first feature reconstruction module, the first feature reconstruction module includes at least two branches, and reconstruction processing is performed on the at least two branches of the first feature reconstruction module to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model. The to-be-processed image is inputted into the optimized image model and image quality enhancement processing is performed. By replacing the first feature reconstruction module of the image model with the second feature reconstruction module, the number of branches of the feature reconstruction module can be reduced, thus reducing the number of parameters of the image model; and by performing image quality enhancement processing on the to-be-processed image through the optimized image model, the image processing efficiency can be improved.

According to another aspect, an embodiment of this disclosure provides an image model processing apparatus, including: an acquisition unit and a processing unit. The acquisition unit is configured to acquire an image model, the image model including a first feature reconstruction module configured to extract feature information of training data, the first feature reconstruction module including at least two branches. The processing unit is configured to perform reconstruction processing on the at least two branches of the first feature reconstruction module to obtain a second feature reconstruction module, the number of branches included in the second feature reconstruction module being less than the number of branches included in the first feature reconstruction module, and the second feature reconstruction module being configured to extract feature information of a to-be-processed image. The processing unit is configured to replace the first feature reconstruction module in the image model with the second feature reconstruction module to obtain an optimized image model, the optimized image model being configured to perform image quality enhancement processing on the to-be-processed image.

In one implementation, the number of branches included in the first feature reconstruction module is N, N being an integer greater than 1, and the processing unit being configured to perform reconstruction processing on the at least two branches of the first feature reconstruction module to obtain a second feature reconstruction module is specifically configured to:
select M target branches from the N branches of the first feature reconstruction module according to a branch selection rule, M being a positive integer less than or equal to N;
and

perform reconstruction processing on the M target branches to obtain the second feature reconstruction module.

In one implementation, the M target branches are first-type branches, the first-type branches are configured to perform feature extraction processing on input data of the first feature reconstruction module, and each first-type branch includes at least one convolution kernel; and the processing unit being configured to perform reconstruction processing on the M target branches to obtain the second feature reconstruction module is specifically configured to:
perform first transformation processing on the convolution kernels in the M target branches to obtain M branches including a first convolution layer; and
merge the M branches including the first convolution layer to obtain the second feature reconstruction module.

In one implementation, the processing unit being configured to perform first transformation processing on the convolution kernels in the M target branches to obtain M branches including a first convolution layer is specifically configured to:
transform a convolution kernel in an i^{th} target branch into the first convolution layer if the number of convolution kernels in the i^{th} target branch is one, i being a positive integer less than or equal to M; and
merge convolution kernels in the i^{th} target branch if the number of convolution kernels in the i^{th} target branch is greater than one, and transform a merged convolution kernel into the first convolution layer.

In one implementation, the M target branches include first-type branches and second-type branches. The first-type branches are configured to perform feature extraction processing on input data of the first feature reconstruction module, and each first-type branch includes at least one convolution kernel. The second-type branches are configured to perform identity transformation processing on the input data of the first feature reconstruction module. The number of the first-type branches is k, k being a positive integer less than M; and
the processing unit being configured to perform reconstruction processing on the M target branches to obtain the second feature reconstruction module is specifically configured to:
perform first transformation processing on the k first-type branches to obtain k branches including a first convolution layer;
performing second transformation processing on M−k second-type branches to obtain M−k branches including a second convolution layer; and
merge the k branches including the first convolution layer and the M−k branches including the second convolution layer to obtain the second feature reconstruction module.

In one implementation, each first-type branch further includes a batch normalization layer, and the batch normalization layer is configured to perform batch normalization processing on feature information outputted from the convolution kernel in the first-type branch.

In one implementation, the N branches include first-type branches, and each first-type branch includes at least one convolution kernel; and the processing unit being configured to select M target branches from the N branches of the first feature reconstruction module according to a branch selection rule is specifically configured to:
select M target branches from the N branches of the first feature reconstruction module randomly; or
select M target branches from the first-type branches according to a preset scale, the scale of the convolution kernels in the M target branches matching the preset scale; or
select M target branches from the first-type branches according to a preset number, the number of the convolution kernels in the M target branches matching the preset number.

In one implementation, the number of second feature reconstruction modules included in the optimized image model is P, P being a positive integer; the optimized image model further includes a feature connection unit; and a process that the optimized image model performs image quality enhancement processing on the to-be-processed image includes:
merging initial feature information of the to-be-processed image with feature information outputted from a j^{th} second feature reconstruction module through the feature connection unit to obtain merged feature information of the to-be-processed image, j being a positive integer less than P;
performing feature extraction on the merged feature information of the to-be-processed image through a (j+1)^{th} second feature reconstruction module to obtain a feature extraction result of the to-be-processed image; and
generating an enhanced image of the to-be-processed image based on the feature extraction result of the to-be-processed image.

In one implementation, the processing unit is further configured to:
perform image quality enhancement processing on the training data through the image model including the first feature reconstruction module to obtain an image quality enhancement result corresponding to the training data; and
adjust parameters in the first feature reconstruction module to obtain an adjusted image model based on a difference between the image quality enhancement result corresponding to the training data and labeled data corresponding to the training data.

In one implementation, the number of branches included in the first feature reconstruction module is N, N being an integer greater than 1; and the processing unit being configured to perform image quality enhancement processing on the training data through the image model including the first feature reconstruction module to obtain an image quality enhancement result corresponding to the training data is specifically configured to:
perform feature extraction on the training data through the N branches respectively to obtain N sub-features corresponding to the training data;
merge the N sub-features to obtain merged feature information of the training data; and
generate the image quality enhancement result corresponding to the training data based on the merged feature information of the training data.

In one implementation, the image model includes at least one first feature reconstruction module, and each first feature reconstruction module corresponds to an activation function.

The image model further includes at least one channel convolution layer, and the at least one channel convolution layer is configured to adjust the number of channels in an image quality enhancement processing process of the to-be-processed image.

In one implementation, the image quality enhancement processing includes upsampling processing. The image model includes an upsampling layer, and a process that the optimized image model performs image quality enhancement processing on the to-be-processed image includes:
performing feature extraction processing on the to-be-processed image through the optimized image model to obtain the feature information of the to-be-processed image; and
performing upsampling processing on the feature information of the to-be-processed image through the upsampling layer to obtain a super-resolution image corresponding to the to-be-processed image.

In one implementation, the image quality enhancement processing includes downsampling processing. The image model includes a downsampling layer, and a process that the optimized image model performs image quality enhancement processing on the to-be-processed image includes:
performing feature extraction processing on the to-be-processed image through the optimized image model to obtain the feature information of the to-be-processed image; and
performing downsampling processing on the feature information of the to-be-processed image through the downsampling layer to obtain a compressed image corresponding to the to-be-processed image.

In one implementation, the image quality enhancement processing includes noise reduction, and a process that the optimized image model performs image quality enhancement processing on the to-be-processed image includes:
performing feature extraction processing on the to-be-processed image through the optimized image model to obtain the feature information of the to-be-processed image; and
generating a noise-reduced image corresponding to the to-be-processed image based on the feature information of the to-be-processed image.

In one implementation, the number of branches included in the first feature reconstruction module is N, the number of branches included in the second feature reconstruction module is Q, N being an integer greater than 1, and Q being an integer greater than or equal to 1 and less than N; and the processing unit being configured to perform feature extraction processing on the to-be-processed image through the optimized image model to obtain the feature information of the to-be-processed image is specifically configured to:
perform feature extraction processing on the to-be-processed image through a branch of the second feature reconstruction module to obtain the feature information of the to-be-processed image if Q is equal to 1; and
perform feature extraction processing on the to-be-processed image through Q branches of the second feature reconstruction module, and merge feature information extracted by the Q branches to obtain the feature information of the to-be-processed image if Q is greater than 1.

According to another aspect, an embodiment of this disclosure provides an image processing apparatus, including: an acquisition unit and a processing unit. The acquisition unit is configured to acquire an image model, the image model including a first feature reconstruction module configured to extract feature information of training data, the first feature reconstruction module including at least two branches. The processing unit is configured to perform reconstruction processing on the at least two branches of the first feature reconstruction module to obtain a second feature reconstruction module, the number of branches included in the second feature reconstruction module being less than the number of branches included in the first feature reconstruction module, and the second feature reconstruction module being configured to extract feature information of a to-be-processed image. The processing unit is configured to replace the first feature reconstruction module in the image model with the second feature reconstruction module to obtain an optimized image model, and input the to-be-processed image into the optimized image model and perform image quality enhancement processing.

Correspondingly, this disclosure provides a computer device. The computer device includes a memory and a processor. The memory has a computer program stored therein. The processor (an example of processing circuitry) is configured to load the computer program to implement the image model processing method described above.

Correspondingly, this disclosure provides a computer-readable storage medium (for example, non-transitory computer-readable storage medium), the computer-readable storage medium having a computer program stored therein, and the computer program being adapted to be loaded by a processor to execute the image model processing method described above.

Correspondingly, this disclosure provides a computer program product or a computer program, the computer program product or the computer program including computer instructions, the computer instructions being stored in a computer-readable storage medium. A processor of a computer device reads the computer instructions from the computer-readable storage medium, and the processor executes the computer instructions, so that the computer device executes the image model processing method described above.

In the embodiment of this disclosure, the image model is acquired. The image model includes the first feature reconstruction module, the first feature reconstruction module includes at least two branches, and reconstruction processing is performed on the at least two branches of the first feature reconstruction module to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model, and the optimized image model is configured to perform image quality enhancement processing on the to-be-processed image. By replacing the first feature reconstruction module of the image model with the second feature reconstruction module, the number of branches of the feature reconstruction module can be reduced, thus reducing the number of parameters of the image model to improve the efficiency of the image model in performing image quality enhancement processing.

### BRIEF DESCRIPTION OF THE DRAWINGS

The following describes technical solutions in embodiments of this disclosure with reference to the accompanying drawings. The described embodiments are some of the embodiments of this disclosure rather than all of the embodiments. Other embodiments are within the scope of this disclosure.

FIG. 1 is an architectural diagram of an image model processing system provided by an embodiment of this disclosure.

FIG. 2 is a flowchart of an image model processing method provided by an embodiment of this disclosure.

FIG. 3a is a schematic diagram of a first feature reconstruction module provided by an embodiment of this disclosure.

FIG. 3b is a schematic diagram of reconstruction provided by an embodiment of this disclosure.

FIG. 4 is a flowchart of another image model processing method provided by an embodiment of this disclosure.

FIG. 5a is a schematic structural diagram of an image model provided by an embodiment of this disclosure.

FIG. 5b is a schematic diagram of image processing provided by an embodiment of this disclosure.

FIG. 5c is another schematic diagram of reconstruction provided by an embodiment of this disclosure.

FIG. 5d is a schematic diagram of a second convolution layer provided by an embodiment of this disclosure.

FIG. 6 is a flowchart of an image processing method provided by an embodiment of this disclosure.

FIG. 7 is a schematic structural diagram of an image model processing apparatus provided by an embodiment of this disclosure.

FIG. 8 is a schematic structural diagram of an image processing apparatus provided by an embodiment of this disclosure.

FIG. 9 is a schematic structural diagram of a computer device provided by an embodiment of this disclosure.

### DESCRIPTION OF EMBODIMENTS

Technical solutions in embodiments of this disclosure are described in the following with reference to the accompanying drawings in the embodiments of this disclosure. The described embodiments are merely some rather than all of the embodiments of this disclosure.

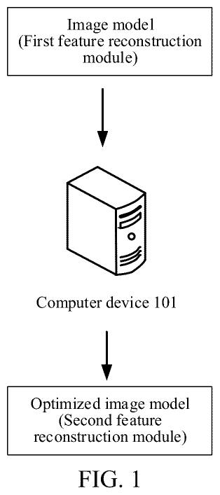

Please refer to FIG. 1. FIG. 1 is an architectural diagram of an image model processing system provided by an embodiment of this disclosure. As shown in FIG. 1, the image model processing system may include: a computer device 101. The image model processing solution provided by the embodiment of this disclosure may be executed by the computer device 101. The computer device 101 may be a terminal device or a server. The terminal device may include, but not limited to, a smart phone (such as an Android mobile phone, an IOS mobile phone), a tablet computer, a portable personal computer, a Mobile Internet Device (MID), an on board terminal, an intelligent household appliance, a wearable device, or any other intelligent device, which is not limited in the embodiment of this disclosure. The server may be an independent physical server, may be a server cluster or distributed system composed of multiple physical servers, or may be a cloud server providing basic cloud computing services such as cloud service, a cloud database, cloud computing, a cloud function, cloud storage, network service, cloud communication, middleware service, domain name service, security service, a Content Delivery Network (CDN), big data, and an artificial intelligence platform, which is not limited in the embodiment of this disclosure.

A terminal device or a server may also be included in FIG. 1. For example, a to-be-processed image is provided to the computer device 101 by the terminal device or the server. In addition, the terminal device or the server may be connected with the computer device 101 in a wired or wireless way, which is not limited in this disclosure.

In specific implementations, the principle of the image model processing solution is substantially as follows:
(1) The computer device 101 acquires an image model. The image model includes a first feature reconstruction module configured to extract feature information of training data (such as training images). The first feature reconstruction module includes at least two branches. The first feature reconstruction module may be configured to extract feature information of an image. The feature information of the image may include, but not limited to, a color feature, an edge feature, a shape feature, and a spatial relationship feature.
(2) After acquiring the image model, the computer device 101 may train the image model including the first feature reconstruction module through the training data to obtain an adjusted image model. Specifically, the computer device 101 may perform image quality enhancement processing on the training data through the image model including the first feature reconstruction module to obtain an image quality enhancement result corresponding to the training data, and adjust parameters (such as convolution kernels) in the first feature reconstruction module to obtain an adjusted image model based on a difference between the image quality enhancement result corresponding to the training data and labeled data corresponding to the training data.
(3) The computer device 101 performs reconstruction processing on the at least two branches of the first feature reconstruction module in the adjusted image model to obtain a second feature reconstruction module. The second feature reconstruction module is configured to extract feature information of a to-be-processed image. The number of branches included in the second feature reconstruction module is less than the number of branches included in the first feature reconstruction module. The number of branches included in the first feature reconstruction module is N, where Nis an integer greater than 1; and the number of branches included in the second feature reconstruction module is Q, where Q is an integer greater than or equal to 1 and less than N.

In one implementation, the first feature reconstruction module includes first-type branches and second-type branches. The first-type branches are configured to perform feature extraction processing on input data of the first feature reconstruction module, and each first-type branch includes at least one convolution kernel. The second-type branches are configured to perform identity transformation processing on the input data of the first feature reconstruction module. Assuming that the first feature reconstruction module includes k first-type branches, where k is a positive integer less than N, the specific implementation that the computer device 101 performs reconstruction processing on the at least two branches of the first feature reconstruction module in the adjusted image model to obtain a second feature reconstruction module is as follows: perform first transformation processing on the k first-type branches to obtain k branches including a first convolution layer, and perform second transformation processing on N-k second-type branches to obtain N-k branches including a second convolution layer, where scales of the first convolution layer and the second convolution layer may be the same or different; and merge the k branches including the first convolution layer and the N-k branches including the second convolution layer to obtain the second feature reconstruction module.

In another implementation, the computer device 101 selects M target branches from the N branches of the first feature reconstruction module according to a branch selection rule (for example, random selection, selection according to a preset convolution kernel scale, or selection according to the number of convolution kernels included in each branch), where Mis a positive integer less than or equal to N. The computer device 101 performs reconstruction processing on the M target branches to obtain reconstructed branches, and replaces the M target branches in the first feature reconstruction module with the reconstructed branches to obtain the second feature reconstruction module.
(4) Replace the first feature reconstruction module in the image model with the second feature reconstruction module to obtain an optimized image model. The optimized image model is configured to perform image quality enhancement processing on the to-be-processed image. The image quality enhancement processing includes any of the following: upsampling processing, downsampling processing, and noise reduction. The optimized image model (including the second feature reconstruction module) has fewer branches than the image model (including the first feature reconstruction module) before optimization; the first feature reconstruction module is trained (i.e., a training effect of the image model is ensured by ensuring the number of branches in the image model, so as to ensure an image quality enhancement effect) in a training process of the image model, reconstruction processing is performed on the trained first feature reconstruction module after training to obtain the second feature reconstruction module, and the first feature reconstruction module is replaced with the second feature reconstruction module (that is, the number of branches in the image model is reduced), thus improving the efficiency of image quality enhancement processing while ensuring the effect of image quality enhancement.

In one implementation, the image quality enhancement processing includes upsampling processing. In another implementation, the image quality enhancement processing is downsampling processing. In yet another implementation, the image quality enhancement processing is noise reduction. For relevant processing processes, reference may be made to relevant description in the following embodiments.

In the embodiment of this disclosure, the image model is acquired. The image model includes the first feature reconstruction module, the first feature reconstruction module includes at least two branches, and the image model including the first feature reconstruction module is trained through the training data to obtain the adjusted image model. Reconstruction processing is performed on the at least two branches of the first feature reconstruction module in the adjusted image model to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model, and the optimized image model is configured to perform image quality enhancement processing on the to-be-processed image. Accordingly, by training the first feature reconstruction module through the training data in the training process, a representation ability of the image model can be ensured; and by replacing the first feature reconstruction module of the image model with the second feature reconstruction module in the application process, the number of branches of the feature reconstruction module can be reduced, thus reducing the number of parameters of the image model to improve the efficiency of the image model in performing image quality enhancement processing.

Based on the above image model processing solution, the embodiment of this disclosure provides a more detailed image model processing method. The image model processing method provided in the embodiment of this disclosure will be described in detail below with reference to the accompanying drawings.

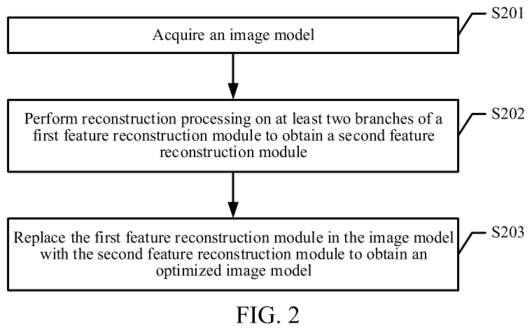

Please refer to FIG. 2. FIG. 2 is a flowchart of an image model processing method provided by an embodiment of this disclosure. The image model processing method may be executed by a computer device. The computer device may be a terminal device or a server. As shown in FIG. 2, the image model processing method may include operation S201 to operation S203.

S201: Acquire an image model.

The image model includes a first feature reconstruction module, and the first feature reconstruction module includes at least two branches. The first feature reconstruction module may be configured to extract feature information of training data (such as training images). The feature information of the image may include, but not limited to, a color feature, an edge feature, a shape feature, and a spatial relationship feature.

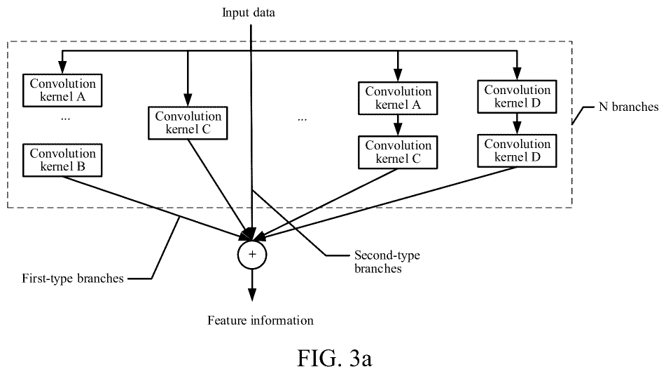

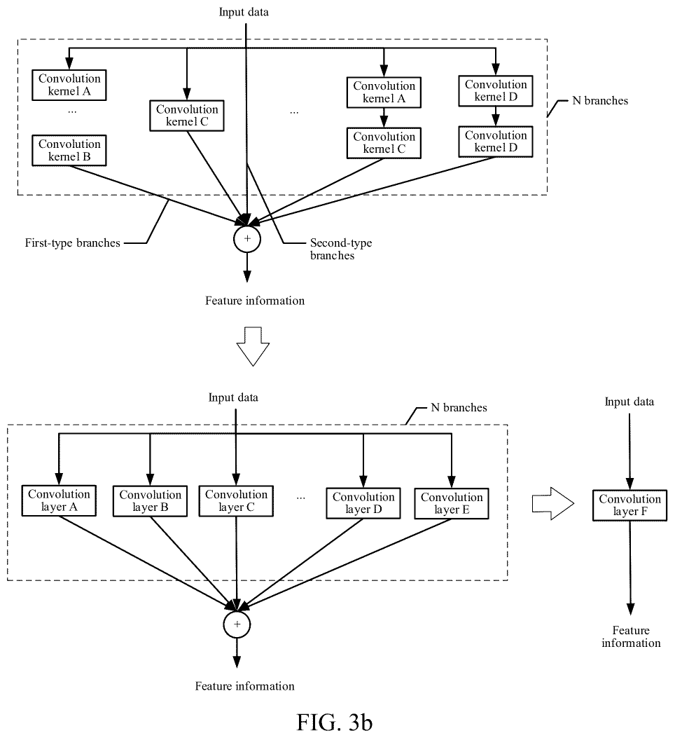

FIG. 3a is a schematic diagram of a first feature reconstruction module provided by an embodiment of this disclosure. As shown in FIG. 3a, the first feature reconstruction module includes N branches, where Nis an integer greater than 1. The N branches included in the first feature reconstruction module may be further divided into first-type branches and second-type branches. Each first-type branch includes at least one convolution kernel. Each first-type branch performs feature extraction processing on input data of the first feature reconstruction module through the at least one convolution kernel. When the number of the convolution kernels included in each first-type branch is multiple (at least two), scales of the convolution kernels may be the same or different. For example, each second-type branch includes a convolution kernel with a scale of 1*1 and a convolution kernel with a scale of 3*3. For another example, each second-type branch includes two convolution kernels with a scale of 3*3. When the number of the first-type branches is multiple, the number of convolution kernels included in each branch may be the same or different For example, the number of convolution kernels included in each first-type branch is the same. Alternatively, the number of convolution kernels included in each first-type branch is different. Alternatively, the number of convolution kernels included in some first-type branches is the same, and the number of convolution kernels included in other first-type branches is different. The second-type branches are configured to perform identity transformation processing on the input data of the first feature reconstruction module.

In some embodiments, the first feature reconstruction module may include first-type branches only.

S202: Perform reconstruction processing on the at least two branches of the first feature reconstruction module to obtain a second feature reconstruction module.

The second feature reconstruction module is configured to extract feature information of a to-be-processed image. The number of branches included in the second feature reconstruction module is less than the number of branches included in the first feature reconstruction module.

In one implementation, the first feature reconstruction module includes first-type branches and second-type branches. Assuming that the first feature reconstruction module includes k first-type branches, where k is a positive integer less than N, the specific implementation that the computer device performs reconstruction processing on the at least two branches of the first feature reconstruction module in the image model to obtain a second feature reconstruction module is as follows:

the computer device performs first transformation processing on the k first-type branches to obtain k branches including a first convolution layer. Specifically, if the number of convolution kernels in each first-type branch is multiple (at least two), the computer device merges the convolution kernels in the branch into one convolution kernel. For example, a convolution kernel with a scale of 1*1 and a convolution kernel with a scale of 3*3 are merged into a convolution kernel with a scale of 3*3. For another example, a convolution kernel with a scale of 3*3 and a convolution kernel with a scale of 5*5 are merged into a convolution kernel with a scale of 7*7. After merging the convolution kernels in each first-type branch into one convolution kernel, the computer device transforms a merged convolution kernel into a first convolution layer to obtain a branch including the first convolution layer. If the number of convolution kernels in each first-type branch is one, the computer device directly transforms the convolution kernel into a first convolution layer to obtain a branch including the first convolution layer.

The computer device performs second transformation processing on the second-type branches to obtain N-k branches including a second convolution layer. The second-type branches are configured to perform identity transformation processing on the input data of the first feature reconstruction module. That is, feature information inputted into the second-type branches is consistent with feature information outputted from the second-type branches. In an embodiment, the computer device 101 adds a second convolution layer to the second-type branches, such that feature information inputted into the second convolution layer is consistent with feature information outputted from the second convolution layer (for example, the value of a center grid of the second convolution layer is 1, and the value of other grids is 0). The scale of the first convolution layer and the scale of the second convolution layer may be the same or different.

Further, the computer device merges the k branches including the first convolution layer and the N-k branches including the second convolution layer to obtain the second feature reconstruction module.

FIG. 3b is a schematic diagram of reconstruction provided by an embodiment of this disclosure. As shown in FIG. 3b, the computer device firstly transforms the first-type branches and the second-type branches in the first feature reconstruction module into branches including a convolution layer, and then merges the N branches to obtain the second feature reconstruction module. Since the number of branches in the second feature reconstruction module is less than the number of branches in the first feature reconstruction module (and the number of parameters in the second feature reconstruction module is also less than the number of parameters in the first feature reconstruction module), the efficiency of the second feature reconstruction module in extracting feature information of an image is better than the efficiency of the first feature reconstruction module in extracting the feature information of the image.

In another implementation, the computer device selects M target branches from the N branches of the first feature reconstruction module according to a branch selection rule (for example, random selection, selection according to a preset convolution kernel scale, or selection according to the number of convolution kernels included in each branch), where M is a positive integer less than or equal to N. The computer device performs reconstruction processing on the M target branches to obtain the second feature reconstruction module.

In an embodiment, the M target branches are all first-type branches. The computer device performs first transformation processing on convolution kernels in the M target branches to obtain M branches including a first convolution layer, then merges the M branches including the first convolution layer to obtain a merged branch, and then replaces the M target branches in the first feature reconstruction module with the merged branch to obtain the second feature reconstruction module. In one implementation, if each target branch includes one convolution kernel, the computer device transforms the convolution kernel in the target branch into a first convolution layer to obtain a branch including the first convolution layer. In another implementation, if each target branch includes multiple (at least two) convolution kernels, the computer device firstly merges the multiple convolution kernels into one convolution kernel, and then transforms a merged convolution kernel into a first convolution layer to obtain a branch including the first convolution layer.

In another implementation, the M target branches include k first-type branches and M−k second-type branches. The computer device performs first transformation processing on the k first-type branches to obtain k branches including a first convolution layer, performs second transformation processing on the M−k second-type branches to obtain M−k branches including a second convolution layer, then merges the k branches including the first convolution layer and the M−k branches including the second convolution layer to obtain a merged branch, and then replaces the M target branches in the first feature reconstruction module with the merged branch to obtain the second feature reconstruction module. In one implementation, if each target branch includes one convolution kernel, the computer device transforms the convolution kernel in the target branch into a first convolution layer to obtain a branch including the first convolution layer. In another implementation, if each target branch includes multiple (at least two) convolution kernels, the computer device firstly merges the multiple convolution kernels into one convolution kernel, and then transforms a merged convolution kernel into a first convolution layer to obtain a branch including the first convolution layer. In yet another implementation, if the target branches are the second-type branches, the computer device adds a second convolution layer to the target branches, such that feature information inputted into the second convolution layer is consistent with feature information outputted from the second convolution layer.

The M branches including the convolution layer may be merged into one branch or may be merged into multiple branches. For example, every j branches are merged into one branch, where j is a positive integer less than M. For another example, the branches are merged according to a convolution layer scale of each branch (for example, branches with the same convolution layer scale are merged). For yet another example, the first-type branches including the first convolution layer are merged into one branch, and the second-type branches including the second convolution layer are merged into another branch.

In yet another implementation, the image model includes P first feature reconstruction modules, where P is an integer greater than 1. Reconstruction strategies of the P first feature reconstruction modules may be the same or different, which is not limited in this disclosure. For example, the number of branches in the P first feature reconstruction modules that are merged in the reconstruction process is the same. For another example, the P first feature reconstruction modules are arranged in sequence in the image model, and the number of branches in the first feature reconstruction modules that are merged in the reconstruction process is directly proportional or inversely proportional to the sequence number. For yet another example, the number of branches in each first feature reconstruction module that are merged in the reconstruction process is determined based on the number of branches with a target convolution kernel (such as convolution kernel with a scale of 3*3) included in the first feature reconstruction module. For another example, the number of branches in each first feature reconstruction module that are merged in the reconstruction process is determined based on the number of convolution kernels (such as two convolution kernels) included in a branch of the first feature reconstruction module.

S203: Replace the first feature reconstruction module in the image model with the second feature reconstruction module to obtain an optimized image model.

The optimized image model is configured to perform image quality enhancement processing on the to-be-processed image. The image quality enhancement processing includes any of the following: upsampling processing, downsampling processing, and noise reduction. The optimized image model (including the second feature reconstruction module) has fewer branches than the image model (including the first feature reconstruction module) before optimization; the first feature reconstruction module is trained (i.e., a training effect of the image model is ensured by ensuring the number of branches in the image model, so as to ensure an image quality enhancement effect) in a training process of the image model, reconstruction processing is performed on the trained first feature reconstruction module after training to obtain the second feature reconstruction module, and the first feature reconstruction module is replaced with the second feature reconstruction module (that is, the number of branches in the image model is reduced), thus improving the efficiency of image quality enhancement processing while ensuring the effect of image quality enhancement.

In one implementation, the image quality enhancement processing is upsampling processing. The image model includes an upsampling layer, and a process that the optimized image model performs image quality enhancement processing on the to-be-processed image includes: perform feature extraction processing on the to-be-processed image through the optimized image model to obtain the feature information of the to-be-processed image, and perform upsampling processing on the feature information of the to-be-processed image through the upsampling layer to obtain a super-resolution image corresponding to the to-be-processed image.

In another implementation, the image quality enhancement processing is downsampling processing. The image model includes a downsampling layer, and a process that the optimized image model performs image quality enhancement processing on the to-be-processed image includes: perform feature extraction processing on the to-be-processed image through the optimized image model to obtain the feature information of the to-be-processed image, and perform downsampling processing on the feature information of the to-be-processed image through the downsampling layer to obtain a compressed image corresponding to the to-be-processed image.

In yet another implementation, the image quality enhancement processing is noise reduction, and a process that the optimized image model performs image quality enhancement processing on the to-be-processed image includes: perform feature extraction processing on the to-be-processed image through the optimized image model to obtain the feature information of the to-be-processed image, and generate a noise-reduced image corresponding to the to-be-processed image based on the feature information of the to-be-processed image.

In the embodiment of this disclosure, the image model is acquired. The image model includes the first feature reconstruction module, the first feature reconstruction module includes at least two branches, and reconstruction processing is performed on the at least two branches of the first feature reconstruction module to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model, and the optimized image model is configured to perform image quality enhancement processing on the to-be-processed image. By replacing the first feature reconstruction module of the image model with the second feature reconstruction module, the number of branches of the feature reconstruction module can be reduced, thus reducing the number of parameters of the image model to improve the efficiency of the image model in performing image quality enhancement processing.

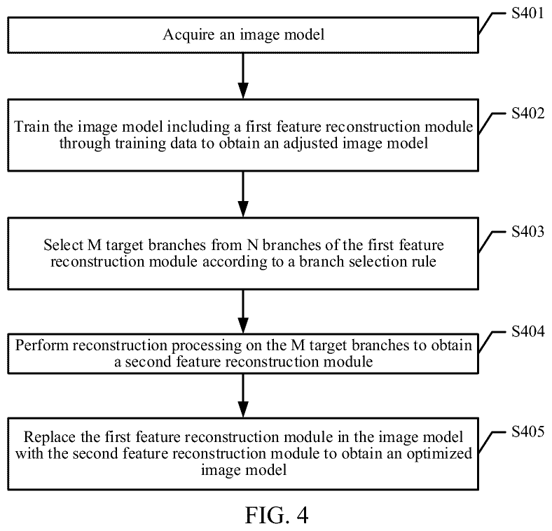

Please refer to FIG. 4. FIG. 4 is a flowchart of another image model processing method provided by an embodiment of this disclosure. The image model processing method may be executed by a computer device. The computer device may be a terminal device or a server. As shown in FIG. 4, the image model processing method may include operation S401 to operation S405.

S401: Acquire an image model.

For the specific implementation of operation S401, reference may be made to the implementation of operation S201 in FIG. 2, which will not be repeated here.

In one implementation, the image model includes at least one first feature reconstruction module, each first feature reconstruction module corresponds to an activation function, and the activation function is configured for introducing a nonlinear feature. The activation function may include, is not limited to, a Prelu activation function, a Relu activation function, and the like. Compared with the Relu activation function, the Prelu activation function can retain more feature information and prevent negative feature values from being set to 0 by the Relu activation function. The image model further includes at least one channel convolution layer, and the at least one channel convolution layer is configured to adjust the number of channels in an image quality enhancement processing process of the to-be-processed image.

S402: Train the image model including the first feature reconstruction module through training data to obtain an adjusted image model.

The computer device performs image quality enhancement processing on the training data through the image model including the first feature reconstruction module to obtain an image quality enhancement result corresponding to the training data. In one implementation, the number of branches included in the first feature reconstruction module is N, where Nis an integer greater than 1. Feature extraction is performed on the training data through the N branches respectively to obtain N sub-features corresponding to the training data; the N sub-features are merged to obtain merged feature information of the training data; and the image quality enhancement result corresponding to the training data is generated based on the merged feature information of the training data. For example, upsampling processing is performed on the merged feature information of the training data to obtain a super-resolution image corresponding to the training data. For another example, downsampling processing is performed on the merged feature information of the training data to obtain a compressed image corresponding to the training data. For yet another example, noise reduction is performed on the merged feature information of the training data to obtain a noise-reduced image corresponding to the training data.

Further, the computer device adjusts parameters in the first feature reconstruction module to obtain the adjusted image model based on a difference between the image quality enhancement result corresponding to the training data and labeled data corresponding to the training data.

In the training process of the image model, the number of branches of the model in a target interval is directly proportional to the feature extraction effect. Training the first feature reconstruction module (including N branches) through the training data can ensure a representation ability of the image model.

S403: Select M target branches from N branches of the first feature reconstruction module according to a branch selection rule.

The N branches include first-type branches, and each first-type branch includes at least one convolution kernel.

In one implementation, the computer device selects M target branches from the N branches of the first feature reconstruction module randomly.

In another implementation, the computer device selects M target branches from the first-type branches according to a preset scale, and the scale of the convolution kernels in the M target branches matches the preset scale. For example, the computer device selects branches including a convolution kernel with a scale of 3*3 from the N branches.

In yet another implementation, the computer device selects M target branches from the first-type branches according to a preset number, and the number of the convolution kernels in the M target branches matches the preset number. For example, the computer device selects branches including two convolution kernels from the N branches.

S404: Perform reconstruction processing on the M target branches to obtain a second feature reconstruction module.

The second feature reconstruction module is configured to extract feature information of a to-be-processed image. The number of branches included in the second feature reconstruction module is less than the number of branches included in the first feature reconstruction module.

In one implementation, the M target branches are first-type branches, the first-type branches are configured to perform feature extraction processing on input data of the first feature reconstruction module, and each first-type branch includes at least one convolution kernel. The computer device performs first transformation processing on convolution kernels in the M target branches to obtain M branches including a first convolution layer. Specifically, if the number of convolution kernels in an i^{th} target branch is one, the computer device transforms a convolution kernel in the i^{th} target branch into the first convolution layer, where i is a positive integer less than or equal to M. If the number of convolution kernels in the i^{th} target branch is greater than one, the computer device merges convolution kernels in the i^{th} target branch, and transforms a merged convolution kernel into the first convolution layer. Further, after obtaining the M branches including the first convolution layer, the computer device merges the M branches including the first convolution layer to obtain a merged branch, and then replaces the M target branches in the first feature reconstruction module with the merged branch to obtain the second feature reconstruction module.

In another implementation, the M target branches include first-type branches and second-type branches. The first-type branches are configured to perform feature extraction processing on input data of the first feature reconstruction module, and each first-type branch includes at least one convolution kernel. The second-type branches are configured to perform identity transformation processing on the input data of the first feature reconstruction module. It is assumed that the number of the first-type branches is k, where k is a positive integer less than M. The computer device performs first transformation processing on the k first-type branches to obtain k branches including a first convolution layer, and performs second transformation processing on M−k second-type branches to obtain M−k branches including a second convolution layer. Specifically, the computer device adds a second convolution layer to the second-type branches, such that feature information inputted into the second convolution layer is consistent with feature information outputted from the second convolution layer. After obtaining the k branches including the first convolution layer and the M−k branches including the second convolution layer, the computer device merges the k branches including the first convolution layer and the M−k branches including the second convolution layer to obtain a merged branch, and then replaces the M target branches in the first feature reconstruction module with the merged branch to obtain the second feature reconstruction module.

In some embodiments, each first-type branch further includes a Batch Normalization (BN) layer, and the batch normalization layer is configured to perform batch normalization processing on feature information outputted from the convolution kernel in the first-type branch. The operation of performing batch normalization processing on the feature information may be understood as: transform feature information with a range difference greater than a threshold or different units into a specified range according to a preset rule. By processing the feature information outputted from the convolution kernel through the batch normalization layer, a convergence speed of the image model can be accelerated.

S405: Replace the first feature reconstruction module in the image model with the second feature reconstruction module to obtain an optimized image model.

The optimized image model is configured to perform image quality enhancement processing on the to-be-processed image. The image quality enhancement processing includes any of the following: upsampling processing, downsampling processing, and noise reduction.

In one implementation, the number of second feature reconstruction modules included in the optimized image model is P, where P is a positive integer. That is, the image model before optimization includes P first feature reconstruction modules. In the optimization (reconstruction processing) process of the P first feature reconstruction modules, reconstruction strategies of the first feature reconstruction modules may be the same or different, which is not limited in this disclosure. For example, the number of branches in the P first feature reconstruction modules that are merged in the reconstruction process is the same. For another example, the P first feature reconstruction modules are arranged in sequence in the image model, and the number of branches in the first feature reconstruction modules that are merged in the reconstruction process is directly proportional or inversely proportional to the sequence number. For yet another example, the number of branches in each first feature reconstruction module that are merged in the reconstruction process is determined based on the number of branches with a target convolution kernel (such as convolution kernel with a scale of 3*3) included in the first feature reconstruction module. For another example, the number of branches in each first feature reconstruction module that are merged in the reconstruction process is determined based on the number of convolution kernels (such as two convolution kernels) included in a branch of the first feature reconstruction module.

In one implementation, the optimized image model further includes a feature connection unit; and a process that the optimized image model performs image quality enhancement processing on the to-be-processed image includes:
the computer device merges initial feature information of the to-be-processed image with feature information outputted from a j^{th} second feature reconstruction module through the feature connection unit to obtain merged feature information of the to-be-processed image, where j is a positive integer less than P. Then, feature extraction is performed on the merged feature information of the to-be-processed image through a (j+1)^{th} second feature reconstruction module to obtain a feature extraction result of the to-be-processed image. After obtaining the feature extraction result of the to-be-processed image, the computer device generates an enhanced image of the to-be-processed image based on the feature extraction result of the to-be-processed image. For example, upsampling processing is performed on the feature extraction result of the to-be-processed image to obtain a super-resolution image corresponding to the to-be-processed image. For another example, downsampling processing is performed on the feature extraction result of the to-be-processed image to obtain a compressed image corresponding to the to-be-processed image. For yet another example, noise reduction is performed on the to-be-processed image according to the feature extraction result of the to-be-processed image to obtain a noise-reduced image corresponding to the to-be-processed image.

The image model may include one or more feature connection units, and the initial feature information of the to-be-processed image is merged with the feature information outputted from the j^{th} second feature reconstruction module through the feature connection units, thus improving the effect of image quality enhancement, reducing the risk of gradient vanishing in the image processing process, and enhancing the performance of the image model.

In one implementation, the image quality enhancement processing includes upsampling processing. In another implementation, the image quality enhancement processing is downsampling processing. In yet another implementation, the image quality enhancement processing is noise reduction. Upsampling processing obtains the super-resolution image corresponding to the to-be-processed image, downsampling processing obtains the compressed image corresponding to the to-be-processed image, and noise reduction generates the noise-reduced image corresponding to the to-be-processed image. For relevant processing modes, reference may be made to relevant descriptions in the embodiments described above.

In one implementation, the number of branches included in the first feature reconstruction module is N, and the number of branches included in the second feature reconstruction module is Q, where N is an integer greater than 1, and Q is an integer greater than or equal to 1 and less than N. In the embodiment above, the specific implementation of performing feature extraction processing on the to-be-processed image through the optimized image model to obtain the feature information of the to-be-processed image is as follows: if Q is equal to 1, the computer device performs feature extraction processing on the to-be-processed image through a branch of the second feature reconstruction module to obtain the feature information of the to-be-processed image; and if Q is greater than 1, the computer device performs feature extraction processing on the to-be-processed image through Q branches of the second feature reconstruction module, and merges feature information extracted by the Q branches to obtain the feature information of the to-be-processed image.

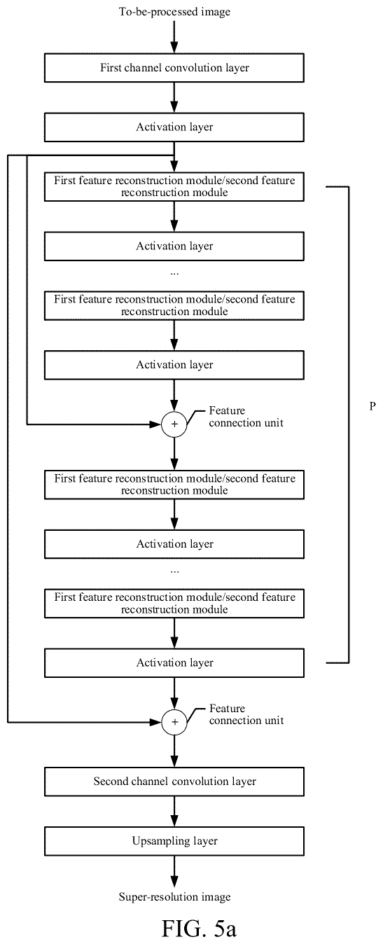

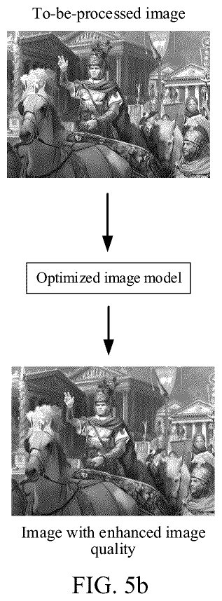

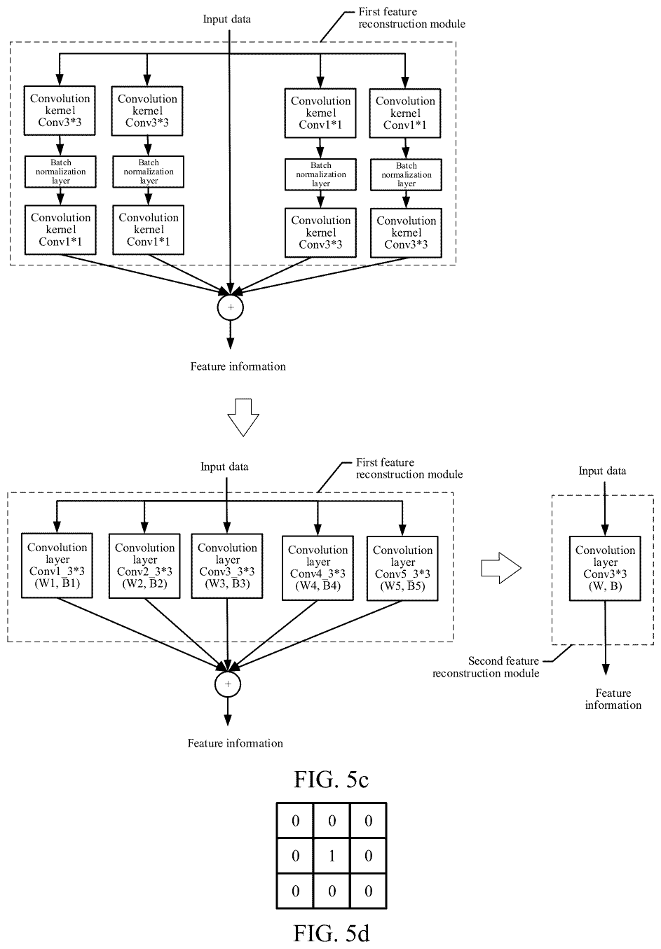

FIG. 5a is a schematic structural diagram of an image model provided by an embodiment of this disclosure. As shown in FIG. 5a, the image model includes a first channel convolution layer (Conv1), a second channel convolution layer (Conv2), an upsampling layer, and P first feature reconstruction modules. Each first feature reconstruction module corresponds to an activation layer. The first channel convolution layer (Conv1) and the second channel convolution layer (Conv2) are configured to adjust the number of channels in an image quality enhancement processing process of a to-be-processed image. The upsampling layer (Piexlshuffle) is configured to perform upsampling processing on feature information of the to-be-processed image. In practical application, the upsampling layer may be replaced with other network layers according to needs (for example, the upsampling layer is replaced with a downsampling layer when compression needs to be performed on the image), or the upsampling layer may be removed (for example, no upsampling layer or downsampling layer is needed when noise reduction needs to be performed on the image). The P first feature reconstruction modules are configured to extract feature information from training data in a training process. After the training of the image model is completed, the P first feature reconstruction modules will be replaced with a second feature reconstruction module (to obtain an optimized image model). The second feature reconstruction module is obtained after reconstruction processing is performed on the first feature reconstruction modules. By performing image quality enhancement processing on the image through the optimized image model, the efficiency of image quality enhancement processing can be improved. The activation layer is based on an activation function and is configured to introduce a nonlinear feature.

FIG. 5b is a schematic diagram of image processing provided by an embodiment of this disclosure. As shown in FIG. 5b, after obtaining an optimized image model, image quality enhancement processing (such as upsampling processing, downsampling processing, or noise reduction) may be performed on a to-be-processed image through the optimized image model to obtain an image with enhanced image quality (such as a super-resolution image, a compressed image, or a noise-reduced image).

A process that the optimized image model performs image quality enhancement processing on the to-be-processed image will be described below in detail with reference to FIG. 5a and FIG. 5b.

An input of the image model may be a picture of any size and format (such as png, bmp, or jpg). The size of the picture may be represented as (H, W, C), where His the height of the picture, W is the width of the picture, and C is the number of channels corresponding to the picture. Taking a picture of a YUV format as an example, the number of channels corresponding to the picture of the YUV format is 1 (that is, C=1), image quality enhancement processing is performed on a Y component through the image model shown in FIG. 5a, and an output result is a super-resolution single-channel image, and a UV component may be interpolated by adopting methods such as bilinear interpolation or bicubic interpolation. When the picture format is RGB, adjustments may be made to the first channel convolution layer (Conv1) and the second channel convolution layer (Conv2). Specifically, when the picture format is YUV, Conv1=1; and when the picture format is RGB, Conv1=3. In the process of performing feature extraction on the picture through the second feature reconstruction module, the number of channels corresponding to the picture may be adjusted or maintained unchanged, which is not limited in this disclosure. Then, dimension adjustment is performed on outputted feature information of the picture through the second channel convolution layer. In addition, in the process of extracting the feature information of the picture, initial feature information of the to-be-processed image is merged with feature information outputted from a j^{th} second feature reconstruction module through a feature connection unit (skip connection), and the initial feature information of the picture can be utilized to form residual learning, thus reducing the difficulty of the image model in extracting the feature information of the to-be-processed image, and allowing the image model to focus on learning gain feature information (a difference between the feature information outputted from the j^{th} second feature reconstruction module and the initial feature information).

FIG. 5c is another schematic diagram of reconstruction provided by an embodiment of this disclosure. As shown in FIG. 5c, five branches of the first feature reconstruction module perform feature extraction on input data, and sub-features extracted by the five branches are merged to obtain the feature information of the to-be-processed image (i.e., the feature information outputted from the first feature reconstruction module). A convolution kernel and a batch normalization layer in each branch can be reconstructed to form a convolution layer, and the number of input and output channels remains unchanged. A convolution kernel with a scale of 3*3 and the batch normalization layer (conv3×3+BN) can be merged to form a convolution kernel with a scale of 3*3, and a convolution kernel with a scale of 3*3 and a convolution kernel with a scale of 1*1 (conv3*3+conv1*1) can be merged to form a convolution kernel with a scale of 3*3 (conv3×3), therefore, the convolution kernel with a scale of 3*3, the batch normalization layer, and the convolution kernel with a scale of 1*1 (conv3×3+BN+conv1×1) can be reconstructed to form a convolution layer with a scale of 3*3 (Conv1_3*3 (W1, B1)), where W1 represents the weight of the convolution layer, B1 represents the bias, and 3*3 represents that the convolution kernel of the convolution layer is 3*3. Similarly, Conv2_3*3 (W2, B2), Conv4_3*3 (W4, B4), and Conv5_3*3 (W5, B5) can be obtained. Second-type branches are configured to perform identity transformation on the input data (that is, inputted feature information is maintained consistent with feature information outputted from the branch). In one implementation, a second convolution layer with a scale of 3*3 (Conv3_3*3) may be added to the second-type branch. FIG. 5d is a schematic diagram of a second convolution layer provided by an embodiment of this disclosure. As shown in FIG. 5d, the value of a center grid of the second convolution layer is 1, and the value of other grids is 0. After the five branches of the first feature reconstruction module are transformed into branches including a convolution layer with a scale of 3*3, these five branches are merged to obtain the second feature reconstruction module. Assuming that the input data is denoted as x and the outputted feature information is denoted as y, the outputted feature information y can be denoted as:

$$y = Conv1\_ 3 * 3 * x + Conv2\_ 3 * 3 * x + Conv3\_ 3 * 3 * x + Conv4\_ 3 * 3 * x + Conv5\_ 3 * 3 * x$$

$$y = Conv 3 * 3 ( W , B ) * x$$

$$where W = W 1 + W 2 + W 3 + W 4 + W 5 , and B = B 1 + B 2 + B 3 + B 4 + B 5.$$

In the embodiment of this disclosure, the image model is acquired. The image model includes the first feature reconstruction module, the first feature reconstruction module includes at least two branches, and the image model including the first feature reconstruction module is trained through the training data to obtain an adjusted image model. Reconstruction processing is performed on the at least two branches of the first feature reconstruction module to obtain the second feature reconstruction module. The number of branches included in the second feature reconstruction module is less than the number of branches included in the first feature reconstruction module. The first feature reconstruction module in the image model is replaced with the second feature reconstruction module to obtain the optimized image model, and the optimized image model is configured to perform image quality enhancement processing on the to-be-processed image. Accordingly, by training the first feature reconstruction module through the training data in the training process, a representation ability of the image model can be ensured; and by replacing the first feature reconstruction module of the image model with the second feature reconstruction module in the application process, the number of branches of the feature reconstruction module can be reduced, thus reducing the number of parameters of the image model to improve the efficiency of the image model in performing image quality enhancement processing.

For FIG. 5c, the input data passes through the five branches shown in FIG. 5c, and the feature information is obtained by adding them together. Mathematically, a Conv3×3 layer with a 3×3 convolution kernel can be formed through reconstruction, and the number of input and output channels remains unchanged. That is, in the embodiment of this disclosure, corresponding branches of the first feature reconstruction module can be mathematically reconstructed to obtain the second feature reconstruction module with fewer branches.

Please refer to FIG. 6. FIG. 6 is a flowchart of an image processing method provided by an embodiment of this disclosure. The image processing method may be executed by a computer device. The computer device may be a terminal device or a server. As shown in FIG. 6, the image processing method may include operation S601 to operation S604.

S601: Acquire an image model.

S602: Perform reconstruction processing on at least two branches of a first feature reconstruction module to obtain a second feature reconstruction module.

S603: Replace the first feature reconstruction module in the image model with the second feature reconstruction module to obtain an optimized image model.

For the specific implementations of operation S601 to operation S603, reference may be made to the implementations of operation S201 to operation S203 in FIG. 2, or the implementations of operation S401 to operation S405 in FIG. 4, which will not be repeated here.

S604: Input a to-be-processed image into the optimized image model and perform image quality enhancement processing.

The image quality enhancement processing includes any of the following: upsampling processing, downsampling processing, and noise reduction.

In one implementation, image quality enhancement processing refers to upsampling processing. The optimized image model includes an upsampling layer and M second feature reconstruction modules, and each second feature reconstruction module corresponds to an activation function (configured for introducing a nonlinear feature), where M is a positive integer. The optimized image model further includes at least one channel convolution layer, and the channel convolution layer is configured to adjust the number of channels in an image quality enhancement processing process of the to-be-processed image. A process of inputting the to-be-processed image into the optimized image model and performing image quality enhancement processing includes: adjust the number of channels in an inputted to-be-processed image through a channel convolution layer, and perform activation processing on a result outputted from the channel convolution layer through an activation layer (constructed based on an activation function) to obtain initial feature information of the to-be-processed image; and perform feature extraction on the initial feature information of the to-be-processed image through M second feature reconstruction modules and the activation function corresponding to each second feature reconstruction module to obtain feature information of the to-be-processed image.

When multiple (at least two) second feature reconstruction modules are provided, the optimized image model may further include one or more feature connection units, each feature connection unit may be configured to connect (merge) the initial feature information of the to-be-processed image and feature information of the to-be-processed image outputted from an i^{th} second feature reconstruction module, and the connected (merged) feature information of the to-be-processed image is inputted to a (i+1)^{th} second feature reconstruction module, where i is a positive integer less than M; or, the feature connection unit may be configured to connect (merge) the feature information of the to-be-processed image outputted from the i^{th} second feature reconstruction module and feature information of the to-be-processed image outputted from a j^{th} second feature reconstruction module, and the connected (merged) feature information of the to-be-processed image is inputted into a (j+1)^{th} second feature reconstruction module, where i and j are positive integers less than M, and i is less than j.

After obtaining the feature information of the to-be-processed image, the computer device may perform upsampling processing on the feature information of the to-be-processed image through the upsampling layer to obtain a super-resolution image corresponding to the to-be-processed image.

In another implementation, image quality enhancement processing is downsampling processing. The optimized image model includes a downsampling layer and M second feature reconstruction modules, and each second feature reconstruction module corresponds to an activation function (configured for introducing a nonlinear feature), where Mis a positive integer. The optimized image model further includes at least one channel convolution layer, and the channel convolution layer is configured to adjust the number of channels in an image quality enhancement processing process of the to-be-processed image. A process of inputting the to-be-processed image into the optimized image model and performing image quality enhancement processing includes: adjust the number of channels in an inputted to-be-processed image through a channel convolution layer, and perform activation processing on a result outputted from the channel convolution layer through an activation layer (constructed based on an activation function) to obtain initial feature information of the to-be-processed image; and perform feature extraction on the initial feature information of the to-be-processed image through M second feature reconstruction modules and the activation function corresponding to each second feature reconstruction module to obtain feature information of the to-be-processed image.

When multiple (at least two) second feature reconstruction modules are provided, the optimized image model may further include one or more feature connection units, each feature connection unit may be configured to connect (merge) the initial feature information of the to-be-processed image and feature information of the to-be-processed image outputted from an i^{th} second feature reconstruction module, and the connected (merged) feature information of the to-be-processed image is inputted to a (i+1)^{th} second feature reconstruction module, where i is a positive integer less than M; or, the feature connection unit may be configured to connect (merge) the feature information of the to-be-processed image outputted from the i^{th} second feature reconstruction module and feature information of the to-be-processed image outputted from a j^{th} second feature reconstruction module, and the connected (merged) feature information of the to-be-processed image is inputted into a (j+1)^{th} second feature reconstruction module, where i and j are positive integers less than M, and i is less than j.

After obtaining the feature information of the to-be-processed image, the computer device may perform downsampling processing on the feature information of the to-be-processed image through the downsampling layer to obtain a compressed image corresponding to the to-be-processed image.

In yet another implementation, image quality enhancement processing is noise reduction, and the image model includes: M second feature reconstruction modules, and each second feature reconstruction module corresponds to an activation function (configured for introducing a nonlinear feature), where M is a positive integer. The optimized image model further includes at least one channel convolution layer, and the channel convolution layer is configured to adjust the number of channels in an image quality enhancement processing process of the to-be-processed image. A process of inputting the to-be-processed image into the optimized image model and performing image quality enhancement processing includes: adjust the number of channels in an inputted to-be-processed image through a channel convolution layer, and perform activation processing on a result outputted from the channel convolution layer through an activation layer (constructed based on an activation function) to obtain initial feature information of the to-be-processed image; and perform feature extraction on the initial feature information of the to-be-processed image through M second feature reconstruction modules and the activation function corresponding to each second feature reconstruction module to obtain feature information of the to-be-processed image.

When multiple (at least two) second feature reconstruction modules are provided, the optimized image model may further include one or more feature connection units, each feature connection unit may be configured to connect (merge) the initial feature information of the to-be-processed image and feature information of the to-be-processed image outputted from an i^{th} second feature reconstruction module, and the connected (merged) feature information of the to-be-processed image is inputted to a (i+1)^{th} second feature reconstruction module, where i is a positive integer less than M; or, the feature connection unit may be configured to connect (merge) the feature information of the to-be-processed image outputted from the i^{th} second feature reconstruction module and feature information of the to-be-processed image outputted from a j^{th} second feature reconstruction module, and the connected (merged) feature information of the to-be-processed image is inputted into a (j+1)^{th} second feature reconstruction module, where i and j are positive integers less than M, and i is less than j.

After obtaining the feature information of the to-be-processed image, the computer device generates a noise-reduced image corresponding to the to-be-processed image based on the feature information of the to-be-processed image.

In one implementation, the number of branches included in the first feature reconstruction module is N, and the number of branches included in the second feature reconstruction module is Q, where N is an integer greater than 1, and Q is an integer greater than or equal to 1 and less than N. In the embodiment above, the specific implementation of performing feature extraction on the initial feature information of the to-be-processed image through the second feature reconstruction modules and the activation function corresponding to each second feature reconstruction module to obtain the feature information of the to-be-processed image is as follows: if Q is equal to 1, the computer device performs feature extraction processing on the to-be-processed image through a branch of the second feature reconstruction module and activates a feature extraction result of the to-be-processed image through the activation function to obtain the feature information of the to-be-processed image; and if Q is greater than 1, the computer device performs feature extraction processing on the to-be-processed image through Q branches of the second feature reconstruction module, merges feature information extracted by the Q branches, and activates merged feature information through the activation function to obtain the feature information of the to-be-processed image.

In the embodiment of this disclosure, by replacing the first feature reconstruction module of the image model with the second feature reconstruction module, the number of branches of the feature reconstruction module can be reduced, thus reducing the number of parameters of the image model; and by performing image quality enhancement processing on the to-be-processed image through the optimized image model, the image processing efficiency can be improved.

The methods of the embodiments of this disclosure are described in detail above. Correspondingly, apparatuses of the embodiments of this disclosure are provided below to better implement the foregoing solutions of the embodiments of this disclosure.

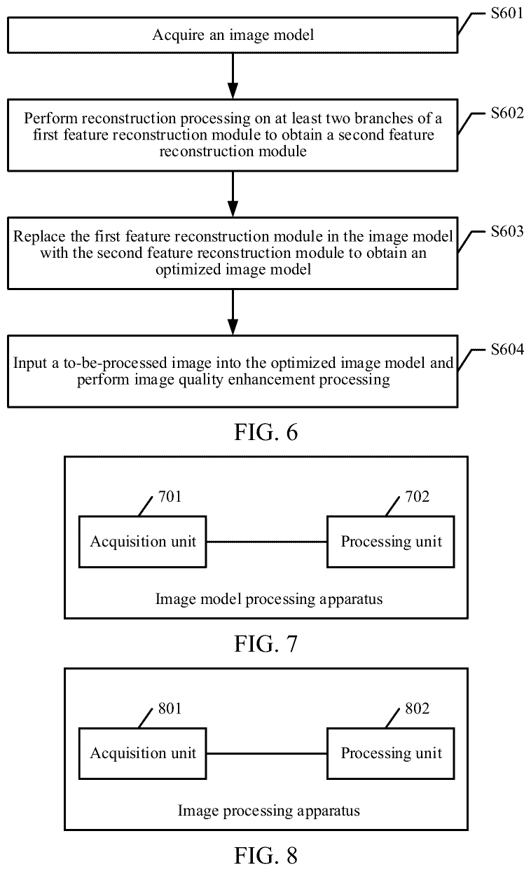

Please refer to FIG. 7. FIG. 7 is a schematic structural diagram of an image model processing apparatus provided by an embodiment of this disclosure. The image model processing apparatus shown in FIG. 7 may be carried in a computer device. The computer device may be specifically a terminal device or a server. The image model processing apparatus may be configured to execute partial or all functions in the method embodiments described in FIG. 2 and FIG. 4. Please refer to FIG. 7, the image model processing apparatus includes:
an acquisition unit 701, configured to acquire an image model, where the image model includes a first feature reconstruction module configured to extract feature information of training data, and the first feature reconstruction module includes at least two branches; and
a processing unit 702, configured to perform reconstruction processing on the at least two branches of the first feature reconstruction module to obtain a second feature reconstruction module, where the number of branches included in the second feature reconstruction module is less than the number of branches included in the first feature reconstruction module, and the second feature reconstruction module is configured to extract feature information of a to-be-processed image;
and configured to replace the first feature reconstruction module in the image model with the second feature reconstruction module to obtain an optimized image model, where the optimized image model is configured to perform image quality enhancement processing on the to-be-processed image.

In one implementation, the number of branches included in the first feature reconstruction module is N, where N is an integer greater than 1, and the processing unit 702 being configured to perform reconstruction processing on the at least two branches of the first feature reconstruction module to obtain a second feature reconstruction module is specifically configured to:
select M target branches from the N branches of the first feature reconstruction module according to a branch selection rule, where M is a positive integer less than or equal to N; and
perform reconstruction processing on the M target branches to obtain the second feature reconstruction module.

In one implementation, the M target branches are first-type branches, the first-type branches are configured to perform feature extraction processing on input data of the first feature reconstruction module, and each first-type branch includes at least one convolution kernel; and the processing unit 702 being configured to perform reconstruction processing on the M target branches to obtain the second feature reconstruction module is specifically configured to:
perform first transformation processing on the convolution kernels in the M target branches to obtain M branches including a first convolution layer; and
merge the M branches including the first convolution layer to obtain the second feature reconstruction module.

In one implementation, the processing unit 702 being configured to perform first transformation processing on the convolution kernels in the M target branches to obtain M branches including a first convolution layer is specifically configured to:
transform a convolution kernel in an i^{th} target branch into the first convolution layer if the number of convolution kernels in the i^{th} target branch is one, where i is a positive integer less than or equal to M; and
merge convolution kernels in the i^{th} target branch if the number of convolution kernels in the i^{th} target branch is greater than one, and transform a merged convolution kernel into the first convolution layer.

In one implementation, the M target branches include first-type branches and second-type branches. The first-type branches are configured to perform feature extraction processing on input data of the first feature reconstruction module, and each first-type branch includes at least one convolution kernel. The second-type branches are configured to perform identity transformation processing on the input data of the first feature reconstruction module. The number of the first-type branches is k, where k is a positive integer less than M; and
the processing unit 702 being configured to perform reconstruction processing on the M target branches to obtain the second feature reconstruction module is specifically configured to:
perform first transformation processing on the k first-type branches to obtain k branches including a first convolution layer;
perform second transformation processing on M−k second-type branches to obtain M−k branches including a second convolution layer; and
merge the k branches including the first convolution layer and the M−k branches including the second convolution layer to obtain the second feature reconstruction module.

In one implementation, each first-type branch further includes a batch normalization layer, and the batch normalization layer is configured to perform batch normalization processing on feature information outputted from the convolution kernel in the first-type branch.

In one implementation, the N branches include first-type branches, and each first-type branch includes at least one convolution kernel; and the processing unit 702 being configured to select M target branches from the N branches of the first feature reconstruction module according to a branch selection rule is specifically configured to:
select M target branches from the N branches of the first feature reconstruction module randomly; or
select M target branches from the first-type branches according to a preset scale, where the scale of the convolution kernels in the M target branches matches the preset scale; or
select M target branches from the first-type branches according to a preset number, where the number of the convolution kernels in the M target branches matches the preset number.

In one implementation, the number of second feature reconstruction modules included in the optimized image model is P, where P is a positive integer; the optimized image model further includes a feature connection unit; and a process that the optimized image model performs image quality enhancement processing on the to-be-processed image includes:
merge initial feature information of the to-be-processed image with feature information outputted from a j^{th} second feature reconstruction module through the feature connection unit to obtain merged feature information of the to-be-processed image, where j is a positive integer less than P;
perform feature extraction on the merged feature information of the to-be-processed image through a (j+1)^{th} second feature reconstruction module to obtain a feature extraction result of the to-be-processed image; and
generate an enhanced image of the to-be-processed image based on the feature extraction result of the to-be-processed image.

In one implementation, the processing unit 702 is further configured to:
perform image quality enhancement processing on the training data through the image model including the first feature reconstruction module to obtain an image quality enhancement result corresponding to the training data; and
adjust parameters in the first feature reconstruction module to obtain an adjusted image model based on a difference between the image quality enhancement result corresponding to the training data and labeled data corresponding to the training data.

In one implementation, the number of branches included in the first feature reconstruction module is N, where N is an integer greater than 1; and the processing unit 702 being configured to perform image quality enhancement processing on the training data through the image model including the first feature reconstruction module to obtain an image quality enhancement result corresponding to the training data is specifically configured to:
perform feature extraction on the training data through the N branches respectively to obtain N sub-features corresponding to the training data;
merge the N sub-features to obtain merged feature information of the training data; and
generate the image quality enhancement result corresponding to the training data based on the merged feature information of the training data.

In one implementation, the image model includes at least one first feature reconstruction module, and each first feature reconstruction module corresponds to an activation function.

The image model further includes at least one channel convolution layer, and the at least one channel convolution layer is configured to adjust the number of channels in an image quality enhancement processing process of the to-be-processed image.

In one implementation, the image quality enhancement processing includes upsampling processing. The image model includes an upsampling layer, and a process that the optimized image model performs image quality enhancement processing on the to-be-processed image includes:
perform feature extraction processing on the to-be-processed image through the optimized image model to obtain the feature information of the to-be-processed image; and
perform upsampling processing on the feature information of the to-be-processed image through the upsampling layer to obtain a super-resolution image corresponding to the to-be-processed image.

In one implementation, the image quality enhancement processing includes downsampling processing. The image model includes a downsampling layer, and a process that the optimized image model performs image quality enhancement processing on the to-be-processed image includes:
perform feature extraction processing on the to-be-processed image through the optimized image model to obtain the feature information of the to-be-processed image; and
perform downsampling processing on the feature information of the to-be-processed image through the downsampling layer to obtain a compressed image corresponding to the to-be-processed image.

In one implementation, the image quality enhancement processing includes noise reduction, and a process that the optimized image model performs image quality enhancement processing on the to-be-processed image includes:
perform feature extraction processing on the to-be-processed image through the optimized image model to obtain the feature information of the to-be-processed image; and
generate a noise-reduced image corresponding to the to-be-processed image based on the feature information of the to-be-processed image.

In one implementation, the number of branches included in the first feature reconstruction module is N, and the number of branches included in the second feature reconstruction module is Q, where N is an integer greater than 1, and Q is an integer greater than or equal to 1 and less than N; and the processing unit 702 being configured to perform feature extraction processing on the to-be-processed image through the optimized image model to obtain the feature information of the to-be-processed image is specifically configured to:
perform feature extraction processing on the to-be-processed image through a branch of the second feature reconstruction module to obtain the feature information of the to-be-processed image if Q is equal to 1; and
perform feature extraction processing on the to-be-processed image through Q branches of the second feature reconstruction module, and merge feature information extracted by the Q branches to obtain the feature information of the to-be-processed image if Q is greater than 1.

According to an embodiment of this disclosure, some operations involved in the image model processing methods shown in FIG. 2 and FIG. 4 may be executed by the units in the image model processing apparatus shown in FIG. 7. For example, operation S201 shown in FIG. 2 may be executed by the acquisition unit 701 shown in FIG. 7, and operation S202 and operation S203 shown in FIG. 2 may be executed by the processing unit 702 shown in FIG. 7. Operation S401 shown in FIG. 4 may be executed by the acquisition unit 701 shown in FIG. 7, and operation S402 to operation S405 may be executed by the processing unit 702 shown in FIG. 7. The units in the image model processing apparatus shown in FIG. 7 may be separately or completely combined into one or more other units, or one (or more) of the units may be split into multiple units with smaller functions. In this way, the same operations can be implemented, without influencing the achievement of the technical effects of the embodiments of this disclosure. The foregoing units are obtained through division based on logical functions. In an actual application, a function of one unit may be implemented by multiple units, or functions of multiple units may be implemented by one unit. In other embodiments of this disclosure, the image model processing apparatus may further include another unit. During practical application, these functions may also be cooperatively implemented by another unit, and may be implemented through collaboration among multiple units.

According to another embodiment of this disclosure, the image model processing apparatus shown in FIG. 7 may be constructed and the image model processing method of the embodiments of this disclosure may be implemented by running a computer program (including a program code) that can be configured to execute the operations involved in the corresponding methods shown in FIG. 2 and FIG. 4 on a general-purpose computing apparatus such as a computer device including processing components and storage components such as a Central Processing Unit (CPU), a Random Access Memory (RAM), and a Read-Only Memory (ROM). The computer program may be recorded in, for example, a computer-readable recording medium, and may be loaded into the foregoing computing apparatus via the computer-readable recording medium and run in the computing apparatus.

In the embodiment of this disclosure, by replacing the first feature reconstruction module of the image model with the second feature reconstruction module, the number of branches of the feature reconstruction module can be reduced, thus reducing the number of parameters of the image model to improve the efficiency of the image model in performing image quality enhancement processing.

Please refer to FIG. 8. FIG. 8 is a schematic structural diagram of an image processing apparatus provided by an embodiment of this disclosure. The image processing apparatus shown in FIG. 8 may be carried in a computer device. The computer device may be specifically a terminal device or a server. The image processing apparatus may be configured to execute partial or all functions in the method embodiment described in FIG. 6. Please refer to FIG. 8, the image processing apparatus includes:
an acquisition unit 801, configured to acquire an image model, where the image model includes a first feature reconstruction module configured to extract feature information of training data, and the first feature reconstruction module includes at least two branches; and
a processing unit 802, configured to perform reconstruction processing on the at least two branches of the first feature reconstruction module to obtain a second feature reconstruction module, where the number of branches included in the second feature reconstruction module is less than the number of branches included in the first feature reconstruction module, and the second feature reconstruction module is configured to extract feature information of a to-be-processed image;
and configured to replace the first feature reconstruction module in the image model with the second feature reconstruction module to obtain an optimized image model;
and configured to input the to-be-processed image into the optimized image model and perform image quality enhancement processing.

According to an embodiment of this disclosure, some operations involved in the image processing method shown in FIG. 6 may be executed by the units in the image processing apparatus shown in FIG. 8. For example, operation S601 shown in FIG. 6 may be performed by the acquisition unit 801 shown in FIG. 8, and operation S602 to operation S604 shown in FIG. 6 may be performed by the processing unit 802 shown in FIG. 8. The units in the image processing apparatus shown in FIG. 8 may be separately or completely combined into one or more other units, or one (or more) of the units may be split into multiple units with smaller functions. In this way, the same operations can be implemented, without influencing the achievement of the technical effects of the embodiments of this disclosure. The foregoing units are obtained through division based on logical functions. In an actual application, a function of one unit may be implemented by multiple units, or functions of multiple units may be implemented by one unit. In other embodiments of this disclosure, the image processing apparatus may further include another unit. During practical application, these functions may also be cooperatively implemented by another unit, and may be implemented through collaboration among multiple units.

According to another embodiment of this disclosure, the image processing apparatus shown in FIG. 8 may be constructed and the image processing method of the embodiment of this disclosure may be implemented by running a computer program (including a program code) that can be configured to execute the operations involved in the corresponding method shown in FIG. 6 on a general-purpose computing apparatus such as a computer device including processing components and storage components such as a Central Processing Unit (CPU), a Random Access Memory (RAM), and a Read-Only Memory (ROM). The computer program may be recorded in, for example, a computer-readable recording medium, and may be loaded into the foregoing computing apparatus via the computer-readable recording medium and run in the computing apparatus.

In the embodiment of this disclosure, by replacing the first feature reconstruction module of the image model with the second feature reconstruction module, the number of branches of the feature reconstruction module can be reduced, thus reducing the number of parameters of the image model; and by performing image quality enhancement processing on the to-be-processed image through the optimized image model, the image processing efficiency can be improved.

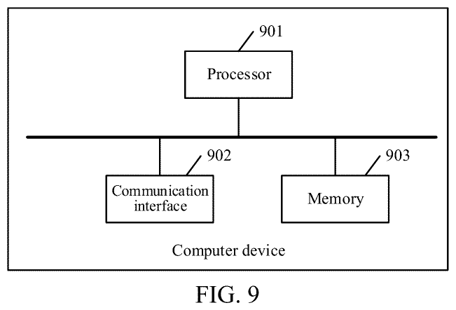

Please refer to FIG. 9. FIG. 9 is a schematic structural diagram of a computer device provided by an embodiment of this disclosure. The computer device may be a terminal device or a server. As shown in FIG. 9, the computer device at least includes a processor 901, a communication interface 902, and a memory 903. The processor 901, the communication interface 902, and the memory 903 may be connected through a bus or by other means. The processor 901 (also known as Central Processing Unit (CPU)) is a computing core and a control core of the computer device, and can parse various instructions within the computer device and process various data of the computer device. For example, the CPU may be configured to parse a power on/off instruction given by an object to the computer device, and control the computer device to perform a power on/off operation. For another example, the CPU may transmit various interactive data between internal structures of the computer device, and the like. The communication interface 902 may include standard wired interfaces, wireless interfaces (such as WI-FI and mobile communication interfaces), and may be configured to transmit and receive data under the control of the processor 901; and the communication interface 902 may also be configured for the transmission and interaction of internal data in the computer device. The memory 903 is a memory device in the computer device and is configured to store programs and data. The memory 903 here may include both a built-in memory of the computer device and an extended memory supported by the computer device. The memory 903 provides a storage space for storing an operating system of the computer device, which may include, but not limited to, Android system, Internetworking Operating System (IOS) or the like, which is not limited in this disclosure.

An embodiment of this disclosure further provides a computer-readable storage medium (Memory). The computer-readable storage medium is a memory device in the computer device and is configured to store programs and data. The computer-readable storage medium here may include both a built-in storage medium of the computer device and an extended storage medium supported by the computer device. The computer-readable storage medium provides a storage space for storing a processing system of the computer device. In addition, the storage space further stores a computer program adapted to be loaded and executed by the processor 901. The computer-readable storage medium here may be a high-speed RAM memory, or a non-volatile memory, for example, at least one magnetic disk; and it may also be at least one computer-readable storage medium located remotely from the processor.

In an embodiment, the processor 901 runs the computer program in the memory 903 to execute the following operations:
acquire an image model, where the image model includes a first feature reconstruction module configured to extract feature information of training data, and the first feature reconstruction module includes at least two branches;
perform reconstruction processing on the at least two branches of the first feature reconstruction module to obtain a second feature reconstruction module, where the number of branches included in the second feature reconstruction module is less than the number of branches included in the first feature reconstruction module, and the second feature reconstruction module is configured to extract feature information of a to-be-processed image;
replace the first feature reconstruction module in the image model with the second feature reconstruction module to obtain an optimized image model, where the optimized image model is configured to perform image quality enhancement processing on the to-be-processed image.

In an embodiment, the number of branches included in the first feature reconstruction module is N, where N is an integer greater than 1; and the specific implementation that the processor 901 performs reconstruction processing on the at least two branches of the first feature reconstruction module to obtain a second feature reconstruction module is as follows:
select M target branches from the N branches of the first feature reconstruction module according to a branch selection rule, where M is a positive integer less than or equal to N; and
perform reconstruction processing on the M target branches to obtain the second feature reconstruction module.

In an embodiment, the M target branches are first-type branches, the first-type branches are configured to perform feature extraction processing on input data of the first feature reconstruction module, and each first-type branch includes at least one convolution kernel; and the specific implementation that the processor 901 performs reconstruction processing on the M target branches to obtain the second feature reconstruction module is as follows:
perform first transformation processing on the convolution kernels in the M target branches to obtain M branches including a first convolution layer; and
merge the M branches including the first convolution layer to obtain the second feature reconstruction module.

In an embodiment, the specific implementation that the processor 901 performs first transformation processing on the convolution kernels in the M target branches to obtain M branches including a first convolution layer is as follows:
transform a convolution kernel in an i^{th} target branch into the first convolution layer if the number of convolution kernels in the i^{th} target branch is one, where i is a positive integer less than or equal to M; and
merge convolution kernels in the i^{th} target branch if the number of convolution kernels in the i^{th} target branch is greater than one, and transform a merged convolution kernel into the first convolution layer.

In an embodiment, the M target branches include first-type branches and second-type branches. The first-type branches are configured to perform feature extraction processing on input data of the first feature reconstruction module, and each first-type branch includes at least one convolution kernel. The second-type branches are configured to perform identity transformation processing on the input data of the first feature reconstruction module. The number of the first-type branches is k, where k is a positive integer less than M; and
the specific implementation that the processor 901 performs reconstruction processing on the M target branches to obtain the second feature reconstruction module is as follows:
perform first transformation processing on the k first-type branches to obtain k branches including a first convolution layer;
perform second transformation processing on M−k second-type branches to obtain M−k branches including a second convolution layer; and
merge the k branches including the first convolution layer and the M−k branches including the second convolution layer to obtain the second feature reconstruction module.

In an embodiment, each first-type branch further includes a batch normalization layer, and the batch normalization layer is configured to perform batch normalization processing on feature information outputted from the convolution kernel in the first-type branch.

In an embodiment, the N branches include first-type branches, and each first-type branch includes at least one convolution kernel; and the specific implementation that the processor 901 selects M target branches from the N branches of the first feature reconstruction module according to a branch selection rule is as follows:
select M target branches from the N branches of the first feature reconstruction module randomly; or
select M target branches from the first-type branches according to a preset scale, where the scale of the convolution kernels in the M target branches matches the preset scale; or
select M target branches from the first-type branches according to a preset number, where the number of the convolution kernels in the M target branches matches the preset number.

In an embodiment, the number of second feature reconstruction modules included in the optimized image model is P, where P is a positive integer; the optimized image model further includes a feature connection unit; and a process that the optimized image model performs image quality enhancement processing on the to-be-processed image includes:
merge initial feature information of the to-be-processed image with feature information outputted from a j^{th} second feature reconstruction module through the feature connection unit to obtain merged feature information of the to-be-processed image, where j is a positive integer less than P;
perform feature extraction on the merged feature information of the to-be-processed image through a (j+1)^{th} second feature reconstruction module to obtain a feature extraction result of the to-be-processed image; and
generate an enhanced image of the to-be-processed image based on the feature extraction result of the to-be-processed image.

In an embodiment, the processor 901 runs the computer program in the memory 903 to further execute the following operations:
perform image quality enhancement processing on the training data through the image model including the first feature reconstruction module to obtain an image quality enhancement result corresponding to the training data; and
adjust parameters in the first feature reconstruction module to obtain an adjusted image model based on a difference between the image quality enhancement result corresponding to the training data and labeled data corresponding to the training data.

In an embodiment, the number of branches included in the first feature reconstruction module is N, where N is an integer greater than 1; and the specific implementation that the processor 901 performs image quality enhancement processing on the training data through the image model including the first feature reconstruction module to obtain an image quality enhancement result corresponding to the training data is as follows:
perform feature extraction on the training data through the N branches respectively to obtain N sub-features corresponding to the training data;
merge the N sub-features to obtain merged feature information of the training data; and
generate the image quality enhancement result corresponding to the training data based on the merged feature information of the training data.

In an embodiment, the image model includes at least one first feature reconstruction module, and each first feature reconstruction module corresponds to an activation function.

The image model further includes at least one channel convolution layer, and the at least one channel convolution layer is configured to adjust the number of channels in an image quality enhancement processing process of the to-be-processed image.

In an embodiment, the image quality enhancement processing includes upsampling processing. The image model includes an upsampling layer, and a process that the optimized image model performs image quality enhancement processing on the to-be-processed image includes:
perform feature extraction processing on the to-be-processed image through the optimized image model to obtain the feature information of the to-be-processed image; and
perform upsampling processing on the feature information of the to-be-processed image through the upsampling layer to obtain a super-resolution image corresponding to the to-be-processed image.

In an embodiment, the image quality enhancement processing includes downsampling processing. The image model includes a downsampling layer, and a process that the optimized image model performs image quality enhancement processing on the to-be-processed image includes:
perform feature extraction processing on the to-be-processed image through the optimized image model to obtain the feature information of the to-be-processed image; and
perform downsampling processing on the feature information of the to-be-processed image through the downsampling layer to obtain a compressed image corresponding to the to-be-processed image.

In an embodiment, the image quality enhancement processing includes noise reduction, and a process that the optimized image model performs image quality enhancement processing on the to-be-processed image includes:
perform feature extraction processing on the to-be-processed image through the optimized image model to obtain the feature information of the to-be-processed image; and
generate a noise-reduced image corresponding to the to-be-processed image based on the feature information of the to-be-processed image.

In an embodiment, the number of branches included in the first feature reconstruction module is N, and the number of branches included in the second feature reconstruction module is Q, where N is an integer greater than 1, and Q is an integer greater than or equal to 1 and less than N; and the specific implementation that the processor 901 performs feature extraction processing on the to-be-processed image through the optimized image model to obtain the feature information of the to-be-processed image is as follows:
perform feature extraction processing on the to-be-processed image through a branch of the second feature reconstruction module to obtain the feature information of the to-be-processed image if Q is equal to 1; and
perform feature extraction processing on the to-be-processed image through Q branches of the second feature reconstruction module, and merge feature information extracted by the Q branches to obtain the feature information of the to-be-processed image if Q is greater than 1.

In another embodiment, the processor 901 runs the computer program in the memory 903 to perform the following operations:
acquire an image model, where the image model includes a first feature reconstruction module configured to extract feature information of training data, and the first feature reconstruction module includes at least two branches;
perform reconstruction processing on the at least two branches of the first feature reconstruction module to obtain a second feature reconstruction module, where the number of branches included in the second feature reconstruction module is less than the number of branches included in the first feature reconstruction module, and the second feature reconstruction module is configured to extract feature information of a to-be-processed image;
replace the first feature reconstruction module in the image model with the second feature reconstruction module to obtain an optimized image model; and
input the to-be-processed image into the optimized image model and performing image quality enhancement processing.

Based on the same inventive concept, the principles and beneficial effects of the computer device provided in the embodiment of this disclosure to solve problems are similar to those of the image model processing method and the image processing method in the method embodiments of this disclosure. Reference may be made to the principles and beneficial effects of the implementation of the methods, which will not be repeated here for the sake of concise description.

An embodiment of this disclosure further provides a computer-readable storage medium. The computer-readable storage medium has a computer program stored therein, and the computer program is adapted to be loaded by a processor to execute the image model processing method in the method embodiment described above, or is adapted to be loaded by the processor to execute the image processing method in the method embodiment described above.

An embodiment of this disclosure further provides a computer program product. The computer program product includes a computer program, and the computer program is adapted to be loaded by a processor to execute the image model processing method in the method embodiment described above, or is adapted to be loaded by the processor to execute the image processing method in the method embodiment described above.

An embodiment of this disclosure further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, so that the computer device executes the image model processing method described above, or executes the image processing method described above.

The operations of the methods in the embodiments of this disclosure may be adjusted in terms of sequence, combined, and deleted according to actual needs.

The modules in the apparatuses in the embodiments of this disclosure may be combined, divided, and deleted according to actual needs.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

It is noted that all or some operations in various methods in the embodiments above may be implemented by a program through instructing related hardware. The program may be stored in a computer-readable storage medium, and the readable storage medium may include: a flash drive, a Read-Only Memory (ROM), a Random Access Memory (RAM), a magnetic disk, an optical disc, or the like.

What are disclosed above are embodiments of this disclosure, which, however, do not intended to limit the scope of claims of this disclosure. It is noted that all or partial processes for implementing the embodiments above, and may make equivalent variations according to the claims of this disclosure, which, however, still fall within the scope of this disclosure.

What is claimed is:

1. A method of image model processing, the method comprising:
acquiring an image model, the image model comprising a first feature reconstruction module configured to extract feature information of training data, the first feature reconstruction module comprising at least two branches;
performing reconstruction processing on the at least two branches of the first feature reconstruction module to obtain a second feature reconstruction module, the second feature reconstruction module having a reduced number of branches compared to the first feature reconstruction module, the at least two branches of the first feature reconstruction module being merged into the reduced number of branches of the second feature reconstruction module, and the second feature reconstruction module being configured to extract feature information of a to-be-processed image; and
replacing the first feature reconstruction module in the image model with the second feature reconstruction module to obtain an optimized image model, the optimized image model being configured to perform image quality enhancement processing on the to-be-processed image.

2. The method according to claim 1, wherein the first feature reconstruction module comprises N branches, N being an integer greater than 1, and the performing the reconstruction processing comprises:
selecting M target branches from the N branches of the first feature reconstruction module according to a branch selection rule, M being a positive integer that is less than or equal to N; and
performing the reconstruction processing on the M target branches to obtain the second feature reconstruction module.

3. The method according to claim 2, wherein the M target branches are first-type branches, the first-type branches are configured to perform feature extraction processing on input data of the first feature reconstruction module, and the first-type branches respectively comprise at least one convolution kernel with trainable parameters for feature extraction, and the performing the reconstruction processing on the M target branches comprises:
performing first transformation processing respectively on the at least one convolution kernel respectively in the M target branches to obtain M branches respectively comprising a first convolution layer; and
merging the M branches respectively comprising the first convolution layer to obtain the second feature reconstruction module.

4. The method according to claim 3, wherein the performing the first transformation processing respectively comprises:
for an i^{th} target branch in the M target branches, i being a positive integer less than or equal to M:
in response to that the i^{th} target branch includes one convolution kernel, transforming the convolution kernel in the i^{th} target branch into the first convolution layer; and
in response to that the i^{th} target branch includes a plurality of convolution kernels, merging the plurality of convolution kernels into a merged convolution kernel and transforming the merged convolution kernel into the first convolution layer.

5. The method according to claim 2, wherein:
the M target branches comprise k first-type branches and M−k second-type branches, k is a positive integer that is less than M, the k first-type branches are configured to perform feature extraction processing on input data of the first feature reconstruction module, and the k first-type branches respectively comprises at least one convolution kernel, the M−k second-type branches are configured to perform identity transformation processing on the input data of the first feature reconstruction module; and
the performing the reconstruction processing on the M target branches comprises:
performing first transformation processing respectively on the k first-type branches to obtain k branches respectively comprising a first convolution layer;
performing second transformation processing respectively on the M−k second-type branches to obtain M−k branches respectively comprising a second convolution layer; and
merging the k branches respectively comprising the first convolution layer and the M−k branches respectively comprising the second convolution layer to obtain the second feature reconstruction module.

6. The method according to claim 2, wherein at least one of the M target branches is a first-type branch configured to perform feature extraction processing on input data of the first feature reconstruction module, and the first-type branch comprises:
at least a convolution kernel; and
a batch normalization layer configured to perform batch normalization processing on feature information outputted from the convolution kernel in the first-type branch.

7. The method according to claim 2, wherein:
the N branches comprise first-type branches, the first-type branches respectively comprising at least one convolution kernel; and
the selecting the M target branches comprises at least one of:
selecting the M target branches from the N branches of the first feature reconstruction module randomly;
selecting the M target branches from the first-type branches according to a preset scale, a scale of convolution kernels in the M target branches matching the preset scale; and/or
selecting the M target branches from the first-type branches according to a preset number, a number of convolution kernels in the M target branches matching the preset number.

8. The method according to claim 1, wherein the optimized image model comprises a feature connection unit and P second feature reconstruction modules including the second feature reconstruction module, P is a positive integer; and the image quality enhancement processing on the to-be-processed image comprises:
merging, by the feature connection unit, initial feature information of the to-be-processed image with feature information outputted from a j^{th} second feature reconstruction module in the P second feature reconstruction modules to obtain merged feature information of the to-be-processed image, j being a positive integer less than P;
performing, by at least a (j+1)^{th} second feature reconstruction module, feature extraction on the merged feature information of the to-be-processed image to obtain a feature extraction result of the to-be-processed image; and
generating an enhanced image of the to-be-processed image based on the feature extraction result of the to-be-processed image.

9. The method according to claim 1, further comprising:
performing, by the image model comprising the first feature reconstruction module, training image quality enhancement processing on the training data to obtain an image quality enhancement result corresponding to the training data; and
adjusting parameters in the first feature reconstruction module based on a difference between the image quality enhancement result corresponding to the training data and labeled data corresponding to the training data to obtain an adjusted image model.

10. The method according to claim 9, wherein the first feature reconstruction module comprises N branches, Nis an integer that is greater than 1, and the performing the image quality enhancement processing comprises:
performing feature extraction on the training data through the N branches respectively to obtain N sub-features corresponding to the training data;
merging the N sub-features to obtain merged feature information of the training data; and
generating the image quality enhancement result corresponding to the training data based on the merged feature information of the training data.

11. The method according to claim 1, wherein:
the image model comprises at least one first feature reconstruction module, each of the at least one first feature reconstruction module corresponding to an activation function; and
the image model further comprises at least one channel convolution layer configured to adjust a number of channels in the image quality enhancement processing of the to-be-processed image.

12. The method according to claim 1, wherein the image quality enhancement processing comprises upsampling processing, the image model comprises an upsampling layer, and the image quality enhancement processing on the to-be-processed image comprises:
performing feature extraction processing on the to-be-processed image by the optimized image model to obtain the feature information of the to-be-processed image; and
performing upsampling processing on the feature information of the to-be-processed image by the upsampling layer to obtain a super-resolution image corresponding to the to-be-processed image.

13. The method according to claim 1, wherein the image quality enhancement processing comprises downsampling processing; the image model comprises a downsampling layer, and the image quality enhancement processing on the to-be-processed image comprises:
performing feature extraction processing on the to-be-processed image by the optimized image model to obtain the feature information of the to-be-processed image; and
performing downsampling processing on the feature information of the to-be-processed image by the downsampling layer to obtain a compressed image corresponding to the to-be-processed image.

14. The method according to claim 1, wherein the image quality enhancement processing comprises noise reduction, and the image quality enhancement processing on the to-be-processed image comprises:
performing feature extraction processing on the to-be-processed image by the optimized image model to obtain the feature information of the to-be-processed image; and
generating a noise-reduced image corresponding to the to-be-processed image based on the feature information of the to-be-processed image.

15. The method according to claim 1, wherein the first feature reconstruction module comprises N branches, the second feature reconstruction module comprises Q branches, N is an integer that is greater than 1, and Q is an integer that is greater than or equal to 1 and less than N; and the image quality enhancement processing on the to-be-processed image comprises:
in response to that Q is equal to 1, performing feature extraction processing on the to-be-processed image by a branch of the second feature reconstruction module to obtain feature information of the to-be-processed image; and
in response to that Q is greater than 1, performing respective feature extraction processing on the to-be-processed image by the Q branches of the second feature reconstruction module to obtain respective sub-features, and merging the respective sub-features to obtain feature information of the to-be-processed image.

16. The method according to claim 1, wherein:
the first feature reconstruction module comprises at least a first branch and a second branch;
the first branch comprises:
at least a first convolution kernel with first trainable parameters for extraction of first feature information; and
a first batch normalization layer configured to perform batch normalization on the first feature information;
the second branch comprises:
at least a second convolution kernel with second trainable parameters for extraction of second feature information; and
a second batch normalization layer configured to perform batch normalization on the second feature information;
the performing the reconstruction processing comprises:
merging at least the first branch and the second branch to obtain the second feature reconstruction module;
the optimized image model comprises: a feature connection unit and P second feature reconstruction modules including the second feature reconstruction module, P is a positive integer; and
the image quality enhancement processing on the to-be-processed image comprises:
merging, by the feature connection unit, initial feature information of the to-be-processed image with feature information outputted from a j^{th} second feature reconstruction module in the P second feature reconstruction modules to obtain merged feature information of the to-be-processed image, j being a positive integer less than P;
performing, by at least a (j+1)^{th} second feature reconstruction module, feature extraction on the merged feature information of the to-be-processed image to obtain a feature extraction result of the to-be-processed image; and
generating an enhanced image of the to-be-processed image based on the feature extraction result of the to-be-processed image.

17. An apparatus for image model processing, comprising processing circuitry configured to:
acquire an image model, the image model comprising a first feature reconstruction module configured to extract feature information of training data, the first feature reconstruction module comprising at least two branches;
perform reconstruction processing on the at least two branches of the first feature reconstruction module to obtain a second feature reconstruction module, the second feature reconstruction module having a reduced number of branches compared to the first feature reconstruction module, and the second feature reconstruction module being configured to extract feature information of a to-be-processed image; and
replace the first feature reconstruction module in the image model with the second feature reconstruction module to obtain an optimized image model, the optimized image model being configured to perform image quality enhancement processing on the to-be-processed image.

18. The apparatus according to claim 17, wherein the first feature reconstruction module comprises N branches, N being an integer greater than 1, and the processing circuitry is configured to:
select M target branches from the N branches of the first feature reconstruction module according to a branch selection rule, M being a positive integer that is less than or equal to N; and
perform the reconstruction processing on the M target branches to obtain the second feature reconstruction module.

19. The apparatus according to claim 17, wherein:
the first feature reconstruction module comprises at least a first branch and a second branch;
the first branch comprises:
at least a first convolution kernel with first trainable parameters for extraction of first feature information; and
a first batch normalization layer configured to perform batch normalization on the first feature information;
the second branch comprises:
at least a second convolution kernel with second trainable parameters for extraction of second feature information; and
a second batch normalization layer configured to perform batch normalization on the second feature information;
the processing circuitry is configured to:
merge at least the first branch and the second branch to obtain the second feature reconstruction module;
the optimized image model comprises: a feature connection unit and P second feature reconstruction modules including the second feature reconstruction module, P is a positive integer; and
the processing circuitry is configured to:
merge, based on the feature connection unit, initial feature information of the to-be-processed image with feature information outputted from a j^{th} second feature reconstruction module in the P second feature reconstruction modules to obtain merged feature information of the to-be-processed image, j being a positive integer less than P;
perform, based on at least a (j+1)^{th} second feature reconstruction module, feature extraction on the merged feature information of the to-be-processed image to obtain a feature extraction result of the to-be-processed image; and
generate an enhanced image of the to-be-processed image based on the feature extraction result of the to-be-processed image.

20. A non-transitory computer-readable storage medium storing instructions which when executed by at least one processor cause the at least one processor to perform:
acquiring an image model, the image model comprising a first feature reconstruction module configured to extract feature information of training data, the first feature reconstruction module comprising at least two branches;
performing reconstruction processing on the at least two branches of the first feature reconstruction module to obtain a second feature reconstruction module, the second feature reconstruction module having a reduced number of branches compared to the first feature reconstruction module, and the second feature reconstruction module being configured to extract feature information of a to-be-processed image; and
replacing the first feature reconstruction module in the image model with the second feature reconstruction module to obtain an optimized image model, the optimized image model being configured to perform image quality enhancement processing on the to-be-processed image.
